(19) United States
(12) Patent Application Publication
(10) Pub. No.: US 2017/0205758 A1
(43) Pub. Date: Jul. 20, 2017

(54) CLEANING MEMBER, CLEANING DEVICE, AND IMAGE FORMING APPARATUS

(71) Applicant: FUJI XEROX CO., LTD., Tokyo (JP)

(72) Inventors: Hiroaki AKAMATSU, Ebina-shi (JP); Masaki HIRAKATA, Minamiashigara-shi (JP)

(73) Assignee: FUJI XEROX CO., LTD., Tokyo (JP)

(21) Appl. No.: 15/247,132

(22) Filed: Aug. 25, 2016

(30) Foreign Application Priority Data
Jan. 19, 2016 (JP) 2016-007777

(51) Int. Cl. G03G 21/00

(52) U.S. Cl. CPC G03G 21/0011

(57) ABSTRACT

A cleaning member includes a contact portion and a supported portion. The contact portion is in contact with an image carrier provided with a protective layer containing an inorganic material on a front surface thereof. The contact portion has a hardness of rubber equal to or greater than 85 degrees. The supported portion includes the contact portion and is supported so that the contact portion is in contact with the image carrier.

### CROSS-REFERENCE TO RELATED APPLICATIONS

This application is based on and claims priority under 35 USC 119 from Japanese Patent Application No. 2016-007777 filed Jan. 19, 2016.

### BACKGROUND

Technical Field

The present invention relates to a cleaning member, a cleaning device, and an image forming apparatus.

### SUMMARY

According to an aspect of an exemplary embodiment of the invention, a cleaning member includes a contact portion and a supported portion. The contact portion is in contact with an image carrier provided with a protective layer containing an inorganic material on a front surface thereof. The contact portion has a hardness of rubber equal to or greater than 85 degrees. The supported portion includes the contact portion and is supported so that the contact portion is in contact with the image carrier.

### BRIEF DESCRIPTION OF THE DRAWINGS

Exemplary embodiments of the present invention will be described in detail based on the following figures, wherein:

FIG. 1 is a view illustrating the entire configuration of an image forming apparatus 1;

FIG. 2 is a view illustrating a configuration of a cleaner 36;

FIG. 3 is a view illustrating a blade 62 when the blade 62 is viewed from an arrow D16 direction;

FIG. 4 is a view illustrating a state of an edge portion 622;

FIG. 5 is a view illustrating a state of the edge portion 622;

FIG. 6 is a view illustrating an evaluation result of wear of the edge portion 622; and

FIGS. 7A to 7C are views illustrating blades 62 according to modification examples.

### DETAILED DESCRIPTION

### Exemplary Embodiment

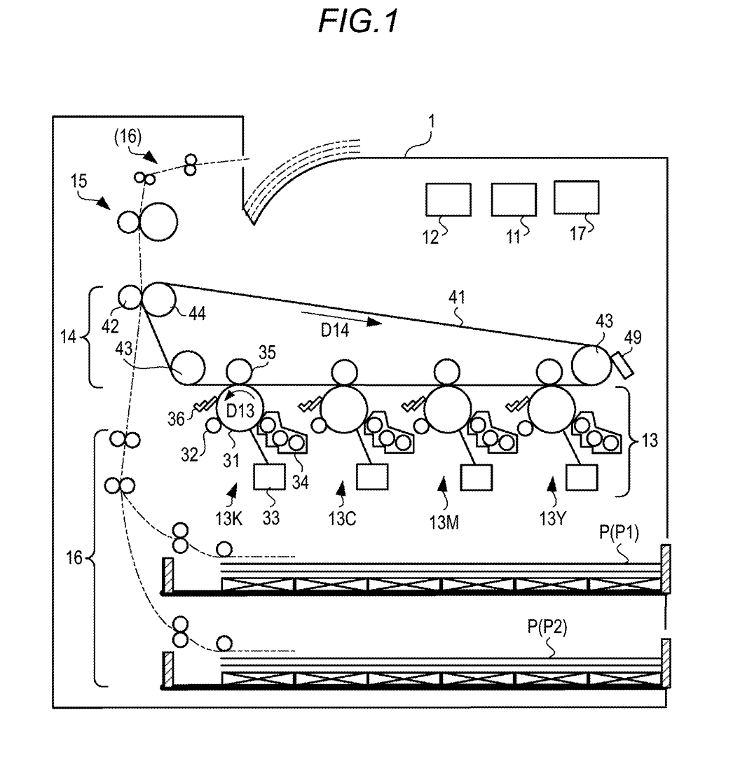

FIG. 1 is a view illustrating the entire configuration of an image forming apparatus 1 according to an exemplary embodiment of the invention. The image forming apparatus 1 is an apparatus which forms an image by an electrophotographic system. The image forming apparatus 1 according to the exemplary embodiment is a so-called tandem type, and forms the image on paper P which is an example of a medium based on image data which indicates the image.

A controller 11 includes a central processing unit (CPU), a read only memory (ROM), and a random access memory (RAM), and controls each portion of the image &liming apparatus 1 as the CPU controls reads and executes a computer program (hereinafter, referred to as a program) stored in the ROM or a memory 12. The memory 12 is a storage device such as a hard disk drive, and stores a program executed by the CPU of the controller 11. An operating portion 17 is provided with an operating button or a touch panel for inputting various instructions, receives the operation from a user, and supplies a signal which corresponds to the contents of an operation to the controller 11.

Developing portions 13Y, 13M, 13C, and 13K form a toner image. In addition, reference numerals Y, M, C, and K denote configurations that correspond to yellow, magenta, cyan, and black toner. Each of the developing portions 13Y, 13M, 13C, and 13K has different toner to be used, and there is not a difference in the configurations. Hereinafter, in a case where it is not particularly necessary to distinguish each of the developing portions 13Y, 13M, 13C and 13K, the alphabets at the end of the reference numerals illustrating the color of the toner will be omitted, and the developing portions will be described as “developing portion 13”. The developing portion 13 is an example of a developing device of the invention.

Each developing portion 13 is provided with a photoconductor drum 31, a charging unit 32, an exposure device 33 (an example of an exposure unit), a developing device 34 (an example of a developing unit), a primary transfer roll 35, and a cleaner 36. The photoconductor drum 31 is, for example, an electrophotographic photoconductor member disclosed in JP-A-2011-65066. The photoconductor drum 31 is an image carrier having a charge generating layer or a charge transport layer, and is rotated in the arrow D13 direction in the drawings by a driving portion which is not illustrated. The photoconductor drum 31 has a protective layer on a front surface. The protective layer includes oxygen and gallium which is an example of an inorganic material. A coefficient of friction of the front surface of the photoconductor drum 31 is set, for example, to be within a range of 0.15 to 0.35, and the coefficient of friction is smaller than that of an organic photoconductor member which is within a range of 0.4 to 0.6. The coefficient of friction is a value obtained by measurement in which a moving speed is 10 min/sec, and a load is 20 g by using a sapphire needle having R of 0.2 mm, using a load change type friction and wear testing system TYPE: HHS2000 front surface properties measuring machine (manufactured by Shinto Scientific Co., Ltd.). In the photoconductor drum 31 having the protective layer, it becomes easy to remove the toner since an adhesive force of the toner becomes weak compared to a photoconductor drum which does not have the protective layer.

The charging unit 32 charges the front surface of the photoconductor drum 31. The exposure device 33 is provided with a laser light generating source or a polygon mirror (both of these are not illustrated), and irradiates the photoconductor drum 31 which is charged by the charging unit 32 with laser light which corresponds to the image data under the control of the controller 11. Accordingly, a latent image is held by each photoconductor drum 31. In addition, the controller 11 may obtain the above-described image data from an external device via a communication portion which is not illustrated. Examples of the external device include a reading apparatus which reads a source image or a computer.

The developing device 34 accommodates a two-component developer including toner having any color of Y, M, C, and K, and magnetic carrier, such as a ferrite powder. In addition, as a tip of a magnetic brush formed in the developing device 34 comes into contact with the front surface of the photoconductor drum 31, the toner is adhered to a part exposed by the exposure device 33 on the front surface of the photoconductor drum 31, that is, an image line portion of an electrostatic latent image, and the image is formed (developed) by the toner in the photoconductor drum 31. The primary transfer roll 35 generates a potential difference determined in advance at a position at which an intermediate transfer belt 41 of a transfer portion 14 opposes the photoconductor drum 31, and transfers the image to the intermediate transfer belt 41 by the potential difference. The cleaner 36 removes the untransferred toner which remains on the front surface of the photoconductor drum 31 after the transfer of the image. In other words, the cleaner 36 is used in forming the next image, and removes unnecessary toner from the photoconductor drum 31.

The transfer portion 14 (an example of a transfer unit) is provided with an intermediate transfer belt 41, a secondary transfer roll 42, a belt transport roll 43, and a backup roll 44, and transfers the image formed by the developing portion 13 to the paper P. The intermediate transfer belt 41 is an endless belt member, and is built across the belt transport roll 43 and the backup roll 44. The driving portion (not illustrated) is provided in at least one of the belt transport roll 43 and the backup roll 44, and moves the intermediate transfer belt 41 in the arrow D14 direction in the drawings. In addition, the belt transport roll 43 or the backup roll 44 which does not have the driving portion rotates following the movement of the intermediate transfer belt 41. As the intermediate transfer belt 41 moves in the arrow D14 direction in the drawings and rotates, the image on the intermediate transfer belt 41 is moved to a region nipped between the secondary transfer roll 42 and the backup roll 44.

The secondary transfer roll 42 transfers the image on the intermediate transfer belt 41 onto the paper P transported from a transport portion 16, by the potential difference between the intermediate transfer belt 41 and the secondary transfer roll 42. A belt cleaner 49 removes the untransferred toner which remains on the front surface of the intermediate transfer belt 41. In addition, the transfer portion 14 transports the paper P to which the image is transferred, to a fixing portion 15.

The fixing portion 15 fixes the image transferred to the paper P, by heating. The transport portion 16 has a container and a transport roll. The sheets of paper P which are an example of media cut into a predetermined size are accommodated in the container. In addition, in the exemplary embodiment, paper P1 and paper P2 having a different size from that of the paper sheet P1 are accommodated. The sheets of paper P accommodated in the container are taken out one by one by the transport roll in accordance with the instruction of the controller 11, and are transported to the transfer portion 14 via a paper transport path. In addition, the medium is not limited to a sheet of paper, and for example, may be a resin-made sheet. In other words, the medium may be a medium which can form an image on the surface thereof.

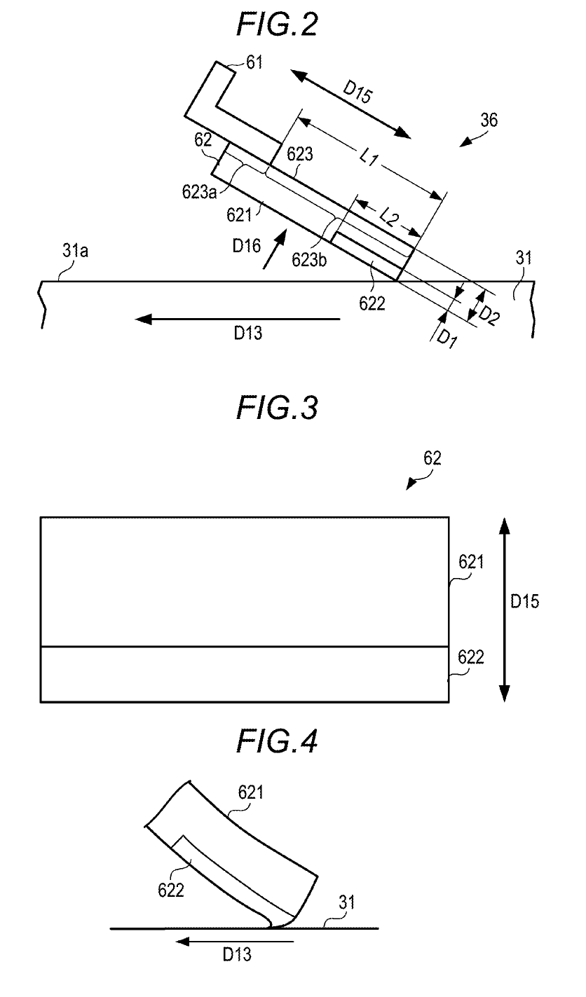

FIG. 2 is a view illustrating a configuration of the cleaner 36, and is a view when the cleaner 36 is viewed from the direction along the rotating shaft of the photoconductor drum 31. The cleaner 36 has a support member 61 and a blade 62. The support member 61 is a support member which supports the blade 62. The support member 61 is fixed to a housing (not illustrated) of the image forming apparatus 1. The blade 62 is an example of a cleaning member according to the invention. In the following description, in order to facilitate to understand, a surface of the blade 62 which faces the photoconductor drum 31 will be referred to as a front surface, and a surface opposite to the front surface will be referred to as a rear surface.

FIG. 3 is a view illustrating the blade 62 when the blade 62 is viewed from the arrow D16 direction of FIG. 2 which is perpendicular to the rear surface. In the exemplary embodiment, the blade 62 comes into contact with a front surface 31a of the photoconductor drum 31. As illustrated in FIGS. 2 and 3, the blade 62 is a plate shaped member. The blade 62 is formed of rubber, and has a body portion 621 and an edge portion 622.

In the exemplary embodiment, the body portion 621 has such a shape that one end side thereof is chipped in a plate shape. In the exemplary embodiment, the body portion 621 is formed of a polyurethane resin. The body portion 621 is fixed to the support member 61 in an end portion 623a. The end portion 623a is fixed to the support member 61 and is not deformed. Meanwhile, a non-fixing portion 623b which is not fixed to the support member 61 in the body portion 621 is deformed by a force received from the outside.

The edge portion 622 has a plate shape in the exemplary embodiment, and has a shape which is fitted to a part which is chipped in a plate shape in the body portion 621. In the exemplary embodiment, the edge portion 622 is formed of a polyurethane resin. As the edge portion 622 is fitted to the chipped part in the body portion 621, the entire blade 62 has a plate shape.

Hardness of the body portion 621 and hardness the edge portion 622 are different from each other. In addition, the hardness means hardness defined by a JIS K 6253 type A, and for example, is measured by an MD-1 hardness meter (manufactured by Kobunshi Keiki Co., Ltd.). In the exemplary embodiment, the hardness of the body portion 621 becomes lower than the hardness of the edge portion 622. It is preferable that the hardness of the edge portion 622 is equal to or greater than 85 degrees.

In the exemplary embodiment, the length from a boundary part between the non-fixing portion 623b and the fixing portion (end portion 623a) in the blade 62 to the end portion of the non-fixing portion 623b, that is, the length of the non-fixing portion 623b in the arrow D15 direction, is “free length L1”. The arrow D15 direction is the direction parallel to the front surface of the blade 62 when the blade 62 is not bent. The length of the edge portion 622 in the arrow D15 direction is “edge width L2”. In addition, in the exemplary embodiment, an angle between a tangential line at a contact point with which a free end of the blade 62 is in contact in the circumferential surface of the photoconductor drum 31 and a surface along the arrow D15 direction of the blade 62 which is in a state of not being bent is referred to as a blade setting angle.

With respect to the photoconductor drum 31 provided with the above-described protective layer, as illustrated in FIG. 4, the edge portion 622 which is in contact with the photoconductor drum 31 is bent and deformed in the rotational direction of the photoconductor drum 31 by the hardness of the edge portion 622. When the edge portion 622 is deformed as illustrated in FIG. 4, the wear of the edge portion 622 proceeds fast, and toner slipping occurs. When the toner slips, the toner which remains on the front surface of the photoconductor drum 31 slips between the blade 62 and the photoconductor drum 31 and remains on the photoconductor drum 31. As the toner slipping occurs, the toner is adhered to the charging unit, and the potential of the photoconductor drum 31 becomes non-uniform, and there is a case where a problem that line-like streaks are venerated in the image to be formed is generated.

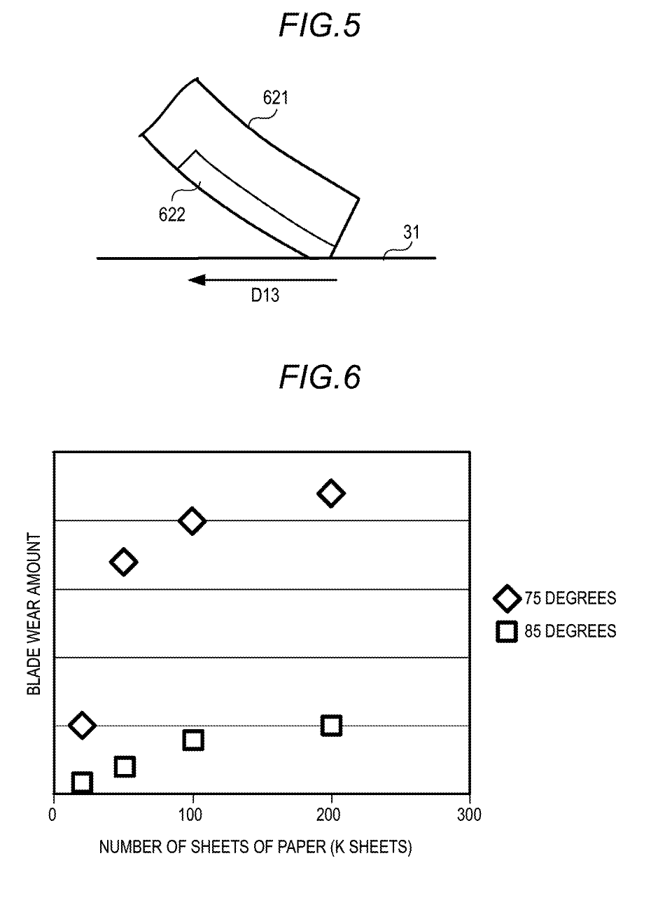

Meanwhile, when the hardness of the edge portion 622 is appropriate, as illustrated in FIG. 5, the edge portion 622 is not deformed in the rotational direction of the photoconductor drum 31. When the blade 62 is disposed in a state illustrated in FIG. 5, the wear of the edge portion 622 proceeds slowly compared to a case where the hardness of the edge portion 622 is small, and the toner slipping is unlikely to occur.

FIG. 6 is a graph illustrating an evaluation result of the wear of the edge portion 622 when an image is formed on the sheet of paper P. In FIG. 6, the vertical shaft is a wear amount of the edge portion 622, and “wear amount=sectional area of the edge portion 622 before starting the measurement−sectional area of the edge portion 622 during the measuring”. In addition, the sectional area of the edge portion 622 is a sectional area in the direction along the arrow D15 direction. In addition, the horizontal shaft of the graph of FIG. 6 is the number of sheets of paper P on which the images are formed. When performing the evaluation, a thickness D2 of the blade 62 is 1.9 mm, the free length L1 is 8 mm, and the blade setting angle is 26 degrees.

In evaluating the edge portion 622, the wear of the edge portion 622 is measured in a case where the hardness of the edge portion 622 is 75 degrees, and the same is measured in a case where the hardness of the edge portion 622 is 85 degrees. In FIG. 6, the measurement result when the image forming is performed in the edge portion 622 of which the hardness is 75 degrees is illustrated by rhomboidal dots, and the measurement result when the image forming is performed in the edge portion 622 of which the hardness is 85 degrees is illustrated by rectangular dots.

As a result of the evaluation, in a case where the hardness of the edge portion 622 is 75 degrees, the contact state of the edge portion 622 with respect to the photoconductor drum 31 becomes a state illustrated in FIG. 4, and when the image forming continues, the wear amount of the edge portion 622 rapidly increases, and a problem that the line-like streaks are generated in the image to be formed is generated.

Meanwhile, in a case where the hardness of the edge portion 622 is 85 degrees, the contact state of the edge portion 622 with respect to the photoconductor drum 31 becomes a state illustrated in FIG. 5, compared to a case where the hardness of the edge portion 622 is 75 degrees, the wear amount of the edge portion 622 does not rapidly increase, and a problem that the line-like streaks are generated in the image to be formed is prevented.

In addition, the inventors evaluate the wear of the edge portion 622 in forming an image on the sheet of paper P in a case where the hardness of the edge portion 622 is 90 degrees and that in a case where the hardness is 95 degrees. Even in a case where the hardness of the edge portion 622 is 90 degrees and in a case where the hardness is 95 degrees, compared to a case where the hardness of the edge portion 622 is 75 degrees, the wear amount of the edge portion 622 does not rapidly increase, and a problem that the line-like streaks are generated in the image to be formed is prevented. In addition, the hardness of the edge portion 622 may exceed 95 degrees, but since a strain increases when the hardness exceeds 95 degrees, it is preferable that the hardness is equal to or less than 95 degrees.

### MODIFICATION EXAMPLE

The exemplary embodiment of the invention is described above. It should be noted that the invention is not limited to the above-described exemplary embodiment. Alternatively, other various exemplary embodiments are possible. Examples thereof will be described below. In addition, each of the following aspects may be combined with each other.

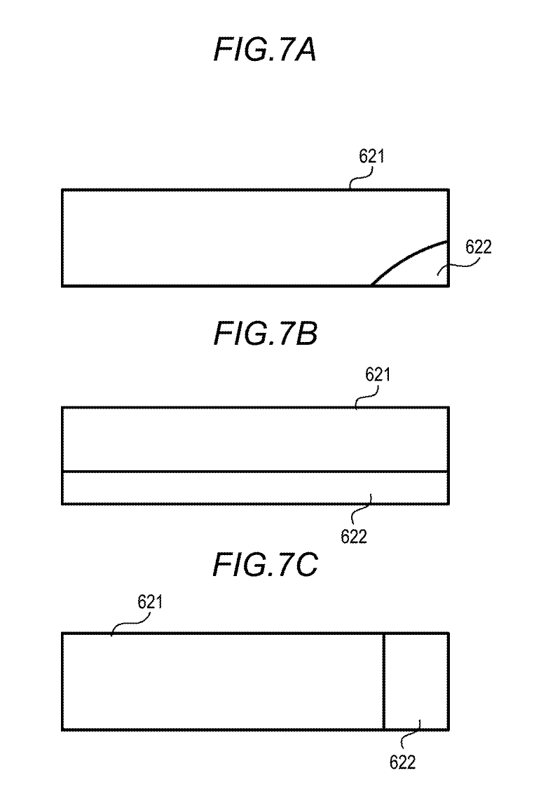

The blade 62 according to the above-described exemplary embodiment has the edge portion 622 has a rectangular shape in section when viewed from the direction along the rotating shaft of the photoconductor drum 31. It should be noted that the shape of the edge portion 622 is not limited to the shape of the above-described exemplary embodiment. FIGS. 7A to 7C are views illustrating the edge portion 622 according to modification examples. As illustrated in FIG. 7A, the edge portion 622 may have a shape in which the surface with which the body portion 621 is in contact is a curved surface. In addition, as illustrated in FIG. 7B, the body portion 621 and the edge portion 622 may have a plate shape, and the body portion 621 and the edge portion 622 may be stacked. In addition, as illustrated in FIG. 7C, the thickness of the plate shaped body portion 621 and the thickness of the edge portion 622 which has a rectangular shape in section when viewed from the direction along the rotating shaft of the photoconductor drum 31, may be the same thickness, and the body portion 621 and the edge portion 622 may be bonded to each other being aligned in the arrow D15 direction.

In the above-described exemplary embodiment, as the edge portion 622 having hardness different from that of the body portion 621 is integrated with the body portion 621, and configures the blade 62, but the configuration of the blade 62 is not limited to the configuration of the exemplary embodiment. For example, impregnating processing may be performed by an isocyanate-based compound in the body portion 621 formed in a plate shape by a polyurethane resin, and the hardness of the body portion 621 may be within a range of 85 degrees to 95 degrees when the hardness of the body portion 621 is measured by the above-described MD-1 hardness meter.

In addition, coating processing may be performed in the body portion 621 formed in a plate shape by a polyurethane resin, and the hardness of the body portion 621 may be within a range of 85 degrees to 95 degrees when the hardness of the body portion 621 is measured by the above-described MD-1 hardness meter. As a coating method, for example, diamond-like carbon is evaporated by chemical vapor deposition (CVD).

In the invention, the cleaner 36 may be configured to include a toner accommodating portion which accommodates the toner removed by the blade, for example, similar to a drum cleaner disclosed in FIG. 9 of JP-A-2008-3146, and may be configured to include a cleaning roll or a collecting roll disclosed in JP-A-2008-3146, and a blade which scrapes the toner adhered to the collecting roll.

The image forming apparatus provided with the blade 62 is not limited to a tandem type of the above-described exemplary embodiment, and may have other configurations, such as a rotary type. In addition, the image forming apparatus provided with the blade 62 is not limited to the image forming apparatus which forms the image by overlapping plural colors of toner images, and may be an image forming apparatus which forms a toner image having a single color.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A cleaning member comprising:
a contact portion that is in contact with an image carrier provided with a protective layer containing an inorganic material on a front surface thereof, the contact portion having a hardness of rubber equal to or greater than 85 degrees; and
a supported portion that includes the contact portion and that is supported so that the contact portion is in contact with the image carrier.

2. The cleaning member according to claim 1,
wherein the supported portion is covered with the contact portion.

3. A cleaning device comprising:
a cleaning member according to claim I; and
an accommodating portion that accommodates toner removed from the image carrier by the contact portion.

4. An image forming apparatus comprising:
an image carrier;
a charging portion that charges the image carrier;
an exposure portion that exposes the image carrier and forms a latent image;
a developing unit that develops the latent image by toner and forms a toner image;
a transfer unit that transfers the toner image to a transferred member; and
a cleaning device according to claim 3.
